(19) United States
(12) Patent Application Publication
(10) Pub. No.: US 2025/0156216 A1
(43) Pub. Date: May 15, 2025

(54) ASYNCHRONOUS TASK EXECUTION FRAMEWORK

(71) Applicant: SAP SE, Walldorf (DE)

(72) Inventors: Vishnu T R, Bangalore (IN); Dhiraj Jaiswal, Bangalore (IN); Prajwel B K, Bangalore (IN)

(21) Appl. No.: 18/506,284

(22) Filed: Nov. 10, 2023

(51) Int. Cl. G06F 9/48; G06F 16/23

(52) U.S. Cl. CPC G06F 9/485; G06F 16/2379

(57) ABSTRACT

Methods, systems, and computer-readable storage media for generating, by a task generation service, task metadata representative of a task that is to be executed in the a cloud-based system, recording the task metadata in a table of a database system, publishing the task metadata to a queueing system, receiving, by a task consuming service of a plurality of task consuming services, the task metadata from the queueing system, executing, by the task consuming service, the task, and during execution, updating a state of the task within the table of the database system.

### BACKGROUND

Cloud computing can be described as Internet-based computing that provides shared computer processing resources and data to computers and other devices on demand. Users can establish respective sessions, during which processing resources and bandwidth are consumed. During a session, for example, a user is provided on-demand access to a shared pool of configurable computing resources (e.g., computer networks, servers, storage, applications, and services). The computing resources can be provisioned and released (e.g., scaled) to meet user demand. In cloud-based environments, applications can be provisioned using services, also referred to as microservices, which have gained popularity in service-oriented architectures (SOAs). In service-based architectures, applications are composed of multiple, independent services, and are deployed in standalone containers with a well-defined interface. The services are deployed and managed by a cloud platform and execute on top of a cloud infrastructure.

### SUMMARY

Implementations of the present disclosure are directed to task execution in cloud-based systems. More particularly, implementations of the present disclosure are directed to an asynchronous task execution framework that uses task metadata and a queuing system to publish tasks for execution and to keep track of states of tasks as the tasks are executed to, for example, completion or failure.

In some implementations, actions include generating, by a task generation service, task metadata representative of a task that is to be executed in the a cloud-based system, recording the task metadata in a table of a database system, publishing the task metadata to a queueing system, receiving, by a task consuming service of a plurality of task consuming services, the task metadata from the queueing system, executing, by the task consuming service, the task, and during execution, updating a state of the task within the table of the database system. Other implementations of this aspect include corresponding systems, apparatus, and computer programs, configured to perform the actions of the methods, encoded on computer storage devices.

These and other implementations can each optionally include one or more of the following features: executing the task is performed in response to validating the task by determining that the state of the task indicates that the task is to be executed; executing the task is performed further in response to validating the task by determining that any precedent task identified in the task metadata was successfully executed; the task metadata includes a retry configuration that defines one or more retriable errors, each representing a respective error, in response to which a retry of execution of the task is allowed; the retry configuration further defines one or more retry intervals for the one or more retriable errors; the task consuming service receives the task metadata in response to the task consuming service being subscribed to the task with the queueing system; and actions further include deleting a message representative of the task in the queueing system in response to one or more of the task being completed and the task failing.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture that can be used to execute implementations of the present disclosure.

FIG. 2 depicts an example asynchronous task execution framework in accordance with implementations of the present disclosure.

FIG. 3 depicts an example state diagram in accordance with implementations of the present disclosure.

FIG. 4 depicts an example process that can be executed in accordance with implementations of the present disclosure.

FIG. 5 is a schematic illustration of example computer systems that can be used to execute implementations of the present disclosure.

Like reference symbols in the various drawings indicate like elements.

### DETAILED DESCRIPTION

Implementations of the present disclosure are directed to task execution in cloud-based systems. More particularly, implementations of the present disclosure are directed to an asynchronous task execution framework that uses task metadata and a queuing system to publish tasks for execution and to keep track of states of tasks as the tasks are executed to, for example, completion or failure. Implementations can include actions of generating, by a task generation service, task metadata representative of a task that is to be executed in the a cloud-based system, recording the task metadata in a table of a database system, publishing the task metadata to a queueing system, receiving, by a task consuming service of a plurality of task consuming services, the task metadata from the queueing system, executing, by the task consuming service, the task, and during execution, updating a state of the task within the table of the database system.

To provide further context for implementations of the present disclosure, and as introduced above, cloud computing can be described as Internet-based computing that provides shared computer processing resources and data to computers and other devices on demand. Users can establish respective sessions, during which processing resources and bandwidth are consumed. During a session, for example, a user is provided on-demand access to a shared pool of configurable computing resources (e.g., computer networks, servers, storage, applications, and services). The computing resources can be provisioned and released (e.g., scaled) to meet user demand. In cloud-based environments, applications can be provisioned using services, also referred to as microservices, which have gained popularity in service-oriented architectures (SOAs). In service-based architectures, applications are composed of multiple, independent services, and are deployed in standalone containers with a well-defined interface. The services are deployed and managed by a cloud platform and execute on top of a cloud infrastructure.

However, issues can arise in execution of multiple tasks across services. For example, a task can implicate execution of multiple other tasks. In distributed, cloud-based applications, a common challenge is asynchronous execution of tasks. Typically, a task is executed in a separate thread without hindering the overall flow. To illustrate this, a non-limiting example can be referenced which includes booking a ticket for travel. In this example, the overall task is generation of the ticket, while other, related tasks can include sending the ticket to the customer using one or more notification channels (e.g., electronic mail (email), short messaging service (SMS)), and notifying an agency about the booking. Such tasks can be done asynchronously and, typically, a separate thread is created for executing each of these tasks.

Even though execution of each task has been initiated, it is difficult to determine whether all of the tasks have been successfully executed. For example, in traditional approaches, status in one or more database columns and/or a file system are checked (e.g., for changes resulting from a successfully executed tasks). In some approaches, code of a service that is used to execute the task need be debugged to understand how the task would have performed. For example, debugging can include checking the code of the service to cross verify with logs and determine whether execution is completed as per the expectations.

Other problems can occur. For example, resiliency need be considered, as there is a chance of losing tasks during execution (e.g., as a result of problems with a pod of an infrastructure that executes a tasks, and/or an instance of a service executing the task). As another example, task ordering need be considered to the extent of determining an order, in which the asynchronous tasks need to be created. As another example, distributed execution need be considered as there is a chance that a pod and/or service instance is overloaded in executing multiple tasks. Dynamic (on-the-fly) configuration can also be considered. For example, static configurations for one or more parameters (e.g., retry period, exception list) are implemented without the ability for dynamic configurations. As another example, traditional approaches do not provide for live tracking, namely knowing what the live status of the task is. As another example, traditional approaches do not support aborting a task before execution.

In view of the foregoing, implementations of the present disclosure provide an asynchronous task execution framework that enables asynchronous execution of multiple tasks. As described in further detail herein, the asynchronous task execution framework of the present disclosure uses task metadata and a queuing system to publish tasks for execution and to keep track of states of tasks as the tasks are executed to, for example, completion or failure. Among other benefits, the asynchronous task execution framework of the present disclosure is a light-weight (in terms of technical resource expended) solution to asynchronous task execution in cloud-based environments, and provides resiliency, progress tracking, dynamic retry configuration, and the like.

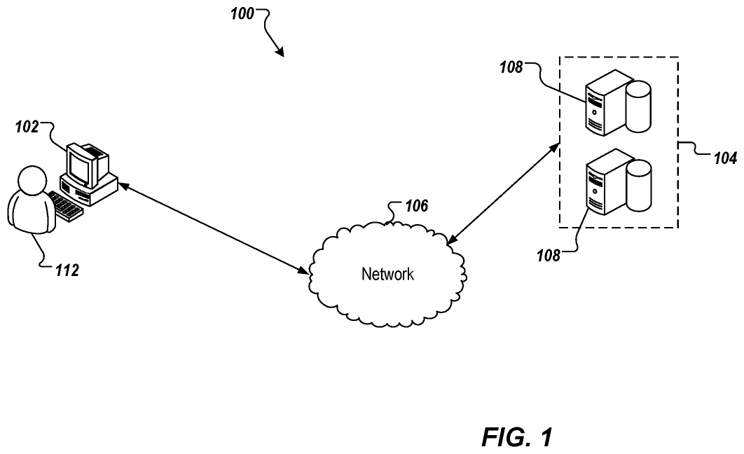

FIG. 1 depicts an example architecture 100 in accordance with implementations of the present disclosure. In the depicted example, the example architecture 100 includes a client device 102, a network 106, and a server system 104. The server system 104 includes one or more server devices and databases 108 (e.g., processors, memory). In the depicted example, a user 112 interacts with the client device 102.

In some examples, the client device 102 can communicate with the server system 104 over the network 106. In some examples, the client device 102 includes any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the server system 104 includes at least one server and at least one data store. In the example of FIG. 1, the server system 104 is intended to represent various forms of servers including, but not limited to a web server, an application server, a proxy server, a network server, and/or a server pool. In general, server systems accept requests for application services and provides such services to any number of client devices (e.g., the client device 102 over the network 106).

In accordance with implementations of the present disclosure, and as noted above, the server system 104 can host one or more cloud-based applications. In some examples, a cloud-based application includes a set of services, each service performing designated functionality. The server system 104 can also maintain an asynchronous task execution framework of the present disclosure to enable asynchronous execution of multiple tasks across two or more services of the cloud-based application.

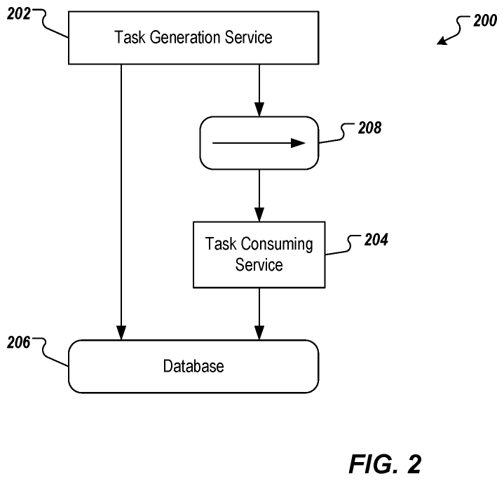

FIG. 2 depicts an example asynchronous task execution framework 200 in accordance with implementations of the present disclosure. In the depicted example, the asynchronous task execution framework 200 includes a task generation service 202, a task consuming service 204, a database system 206, and a queueing system 208.

In some implementations, the task generation service 202 is a service that initiates a task that is to be executed by another service. In this sense, the task generation service 202 can be a service that is leveraged by an application and that, itself, includes functionality that is dependent on functionality of another service, such as the task consuming service 204. In accordance with implementations of the present disclosure, the task generation service 202 generates task metadata that is descriptive of the task that is to be executed. In some examples, the task generation service 202 persists the task metadata in the database system 206 and publishes the task metadata to the queueing system 208. For example, the task generation service 202 serializes the task metadata and executes a create method to create a task metadata file, persists the task metadata to the database system 206, and publishes the task metadata to the queueing system 208. In some examples, serializing includes, but is not limited to, stating the task that is to be performed (e.g., using a task identifier (taskid) and/or operation name (operation)), identifying one or more tasks that precedes the task (e.g., as precedent jobs by respective taskids), configuring retry exceptions, and the like.

In some examples, the task metadata is provided in a computer-readable file (e.g., Javascript object notation (JSON) file) and includes task details including, but not limited to, identifying the task that is to be performed by taskid and/or operation, identifier for the task consuming service, if any, any dependent tasks (e.g., precedent tasks), any supporting payload for execution of the task, and retry configuration (e.g., which exceptions need to be retried along with retry interval for each). Listing 1 provides a non-limiting example of task metadata in accordance with implementations of the present disclosure:

```
Listing 1: Example Task Metadata
{
  “taskid” : “123”,
  “operation” : “UPDATE_PAID_FLOW ”,
  “source” : “BillingService”,
  “messageGroupID” : “aabb-ccdd-qwerty”,
  “identifier” :
    {
      “identifier1” : “”,
      “identifier2” : “”,
      “identifier3” : “”
    },
  “precedentJobs” :
    {“taskid” : “121”, “status” : “Success”},
    {“taskid” : “122”, “status” : “Success”}
  ],
  “retryConfig” :
  {
  “exceptions” :
        “FileNotFoundException”,
        “HTTPServerException”
      ],
    “retryInterval” : [
          {“readCount” : 1, “visibilityCount” : 60000},
          {“readCount” : 2, “visibilityCount” : 1200000}
    ],
  },
  “jsonPayload” : “”
}
```

In the example of Listing 1, the operation tells a task consuming service what task is to be performed.

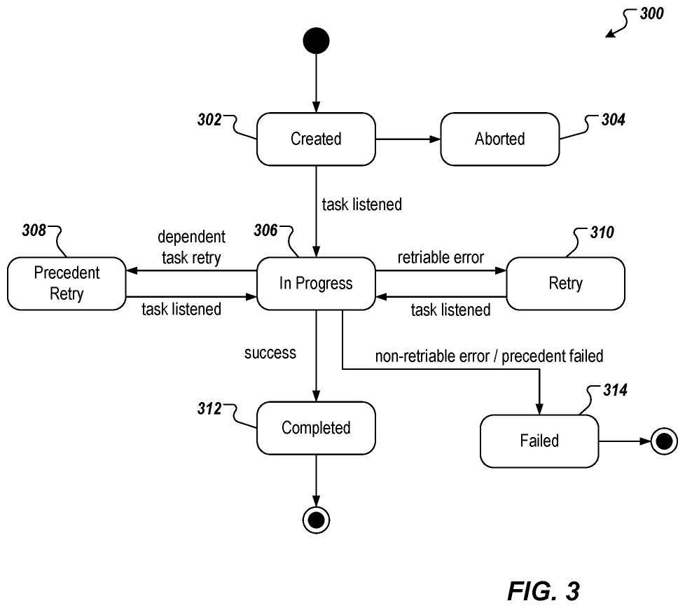

In accordance with implementations of the present disclosure, after creation, each task is associated with a state in a set of states. The set of states can be visualized as a state diagram. FIG. 3 depicts an example state diagram 300 in accordance with implementations of the present disclosure. In the depicted example, the state diagram 300 includes a created state 302, an aborted state 304, an in progress state 306, a precedent retry state 308, a retry state 210, a completed state 312, and a failed state 314.

The created state 302 is an initial state of the task after the task metadata is created, stored in the database system 206 and is published to the queueing service 208. In some instances, the task can be aborted prior to being acted on by a task consuming service, such as the task consuming service 204. For example, the task generation service that initiated the task, such as the task generation service 202, can abort the task. As another example, if the task is dependent on a precedent task and the precedent task fails, the task can be aborted.

The task is in the in progress state 306 in response to a task consuming service, such as the task consuming service 204, reading the task from the queueing system 208, as described in further detail herein. The task is in the precedent retry state 308, if one or more precedent tasks that need to be performed successfully prior to executing the task are being retried (e.g., due to an exception). The task is in the retry state 310, if, during execution of the task, an exception that is defined in the retry configuration (retryConfig) of the task metadata is encountered. The task is in the completed state 312, if the task is successfully executed. The task is in the failed state 314, if a precedent task fails or an exception to the task is encountered and the retry fails.

In some implementations, the state of the task is updated in the database system 206 each time the state changes. For example, upon generation of the task metadata and publishing to the queueing system 208, the state of the task is recorded as in the created state 302 in the database system 206. After the task is picked up by a task consuming service, such as the task consuming service 204, the state of the task is updated to the in progress state 306 in the database system 206.

Referring again to FIG. 2, in some implementations, the queueing system 208 can be provided as a publish-subscribe system, to which task generation services, such as the task generation service 202, publishes tasks, and task consuming services, such as the task consuming service 204, subscribes. In some examples, the queueing system 208 is provided as a managed message queue service, such as, but not limited to, the Simple Queue Service (SQS), first-in, first-out (FIFO) provided by Amazon Web Services, Inc.

In some implementations, the task consuming service 204 subscribes to the queueing system 208 for one or more tasks. For example, the task consuming service 204 can subscribe based on taskid and/or operation. When a task having a taskid and/or operation that the task consuming service 204 is subscribed to is published as a message to the queueing system 208, the task consuming service 204 reads the message. For example, the task consuming service 204 reads the task metadata for the task from the queueing system 208.

In some implementations, after reading the message for the task, the task consuming service 204 descrializes the task metadata and validates the task and any precedent tasks. In some examples, validation includes querying the database system 206 to determine whether the taskid of the task, and taskids of any precedent tasks, are present in the database system 206. In some examples, validation also includes determining a state of the task, and any precedent tasks, as recorded in the database system 206. For example, if the task is in the aborted state, then the task is not validated.

In some examples, if the task, and any precedent tasks are validated, the task consuming service 204 executes a start method to begin performing the task. In some examples, execution of the start method includes updating the database system 206 to change the state of the task from created to in progress. For execution of the task, the statuses of any precedent tasks are checked with the database system 206. For example, the task consuming service 204 can query the database system 206 based on tasked, which returns as state of the respective precedent task. If the state of all precedent tasks is completed, execution of the task continues. If any precedent task is of the retry state, execution of the tasks holds until the retry is conducted. If any precedent task is of the failed state, the task is moved to the failed state and the message that had triggered action by the task consuming service 204 is deleted from queueing system 208.

If, during execution of the task, a retriable error is encountered, the task moves to the retry state. Retriable errors are identified in the retry configuration (retryConfig) of the task metadata, as well as the retry interval(s) for the identified retriable errors. For example, and with reference to a task associated with the task metadata of Listing 1, if either a FileNotFoundException or a HTTPServerException is encountered, a retry is performed based on the retry configuration. However, if another error is encountered (i.e., an error not identified in the retry configuration), the task is deemed to have failed, the task is moved to the failed state and the message that had triggered action by the task consuming service 204 is deleted from queueing system 208. If the task is performed successfully, the task is moved to the completed state and the message that had triggered action by the task consuming service 204 is deleted from queueing system 208.

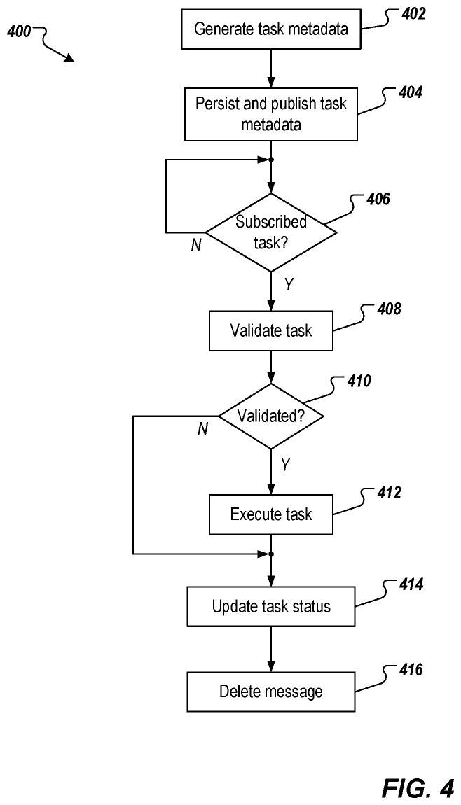

FIG. 4 depicts an example process 400 that can be executed in accordance with implementations of the present disclosure. In some examples, the example process 400 is provided using one or more computer-executable programs executed by one or more computing devices.

Task metadata is generated (402). For example, and as described herein with reference to FIG. 2, the task generation service 202 generates task metadata that is descriptive of a task that is to be executed. The task metadata is persisted and published (404). For example, and as described herein, the task generation service 202 persists the task metadata in the database system 206 and publishes the task metadata to the queueing system 208. For example, the task generation service 202 serializes the task metadata and executes a create method to create a task metadata file, persists the task metadata to the database system 206, and publishes the task metadata to the queueing system 208.

It is determined whether a service that is subscribed to the task is available (406). For example, and as described herein, task consuming services, such as the task consuming service 204, subscribe to tasks that can be published to the queueing system 208. In some examples, if a task consuming service is available to consume a task, tasks that are published to the queueing system 208 are listened for. That is, for example, a task consuming service can listen for publication of a task that it can consume at the queueing system 208. If a service is not available, the example process 400 loops back.

If a service is available, the service receives the task metadata and validates the task (408). For example, and as described herein, the task consuming service 204 reads the task metadata for the task from the queueing system 208, deserializes the task metadata, and validates the task and any precedent tasks. It is determined whether the task has been validated (410). For example, and as described herein, validation includes querying the database system 206 to determine whether the taskid of the task, and taskids of any precedent tasks, are present in the database system 206. In some examples, validation also includes determining a state of the task, and any precedent tasks, as recorded in the database system 206. For example, if the task is in the aborted state, then the task is not validated.

If the task has been validated, the task is executed (412). For example, and as described herein, the task consuming service 204 executes a start method to begin performing the task. In some examples, execution of the start method includes updating the database system 206 to change the state of the task from created to in progress. After execution of the task, the task can be in one of the completed state or the failed state. A status of the task is updated (414) and the message is deleted (416). For example, and as described herein, the task consuming service 204 updates the status of the task in the database system 206 (e.g., to the completed state or the failed state) and deletes the message from the queueing system 208. That is, the message that was originally published to the queueing system 208 for the task is deleted from the queueing system 208.

Implementations of the present disclosure achieve one or more technical improvements. For example, the asynchronous task execution framework provides a relatively light weight (in terms of technical resources, such as processors and memory), resilient, cloud-based solution for asynchronous execution of tasks. The asynchronous task execution framework enables progress of each task to be tracked and, if a task fails, the reason for the failure is provided. Further, implementations of the present disclosure enable dynamic retry configurations that are recorded in task metadata, enabling different retry configurations to be used for different tasks and/or for the same task at different times. That is, retry configurations can be provided for on-the-fly, as tasks are published for execution. The asynchronous task execution framework accounts for inter-task dependencies through definitions provided in the task metadata.

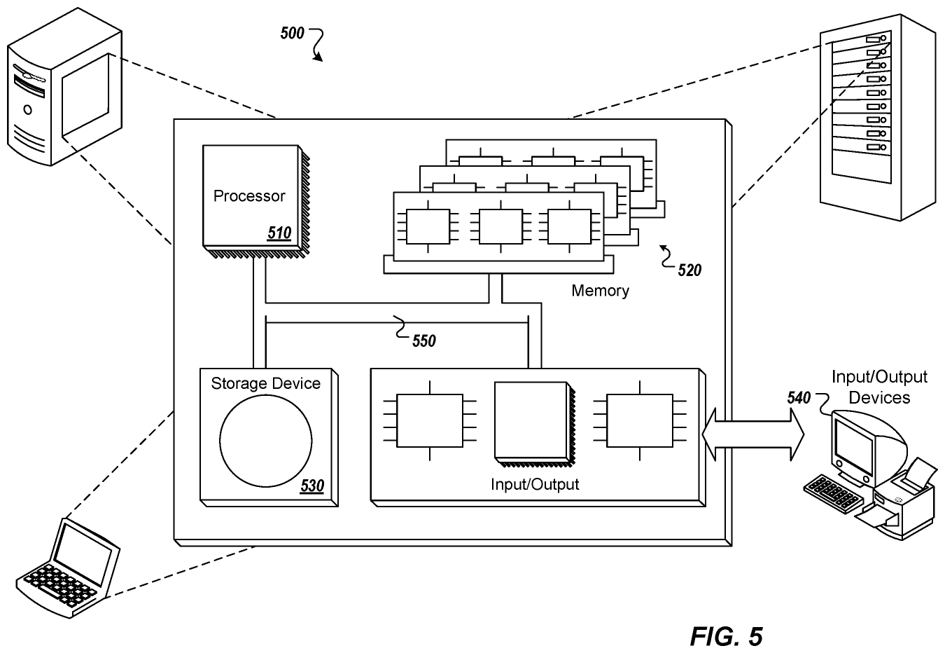

Referring now to FIG. 5, a schematic diagram of an example computing system 500 is provided. The system 500 can be used for the operations described in association with the implementations described herein. For example, the system 500 may be included in any or all of the server components discussed herein. The system 500 includes a processor 510, a memory 520, a storage device 530, and an input/output device 540. The components 510, 520, 530, 540 are interconnected using a system bus 550. The processor 510 is capable of processing instructions for execution within the system 500. In some implementations, the processor 510 is a single-threaded processor. In some implementations, the processor 510 is a multi-threaded processor. The processor 510 is capable of processing instructions stored in the memory 520 or on the storage device 530 to display graphical information for a user interface on the input/output device 540.

The memory 520 stores information within the system 500. In some implementations, the memory 520 is a computer-readable medium. In some implementations, the memory 520 is a volatile memory unit. In some implementations, the memory 520 is a non-volatile memory unit. The storage device 530 is capable of providing mass storage for the system 500. In some implementations, the storage device 530 is a computer-readable medium. In some implementations, the storage device 530 may be a floppy disk device, a hard disk device, an optical disk device, or a tape device. The input/output device 540 provides input/output operations for the system 500. In some implementations, the input/output device 540 includes a keyboard and/or pointing device. In some implementations, the input/output device 540 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for asynchronous task execution in cloud-based systems, the method being executed by one or more processors and comprising:
generating, by a task generation service, task metadata representative of a task that is to be executed in the a cloud-based system;
recording the task metadata in a table of a database system;
publishing the task metadata to a queueing system;
receiving, by a task consuming service of a plurality of task consuming services, the task metadata from the queueing system;
executing, by the task consuming service, the task; and
during execution, updating a state of the task within the table of the database system.

2. The method of claim 1, wherein executing the task is performed in response to validating the task by determining that the state of the task indicates that the task is to be executed.

3. The method of claim 2, wherein executing the task is performed further in response to validating the task by determining that any precedent task identified in the task metadata was successfully executed.

4. The method of claim 1, wherein the task metadata comprises a retry configuration that defines one or more retriable errors, each representing a respective error, in response to which a retry of execution of the task is allowed.

5. The method of claim 4, wherein the retry configuration further defines one or more retry intervals for the one or more retriable errors.

6. The method of claim 1, wherein the task consuming service receives the task metadata in response to the task consuming service being subscribed to the task with the queueing system.

7. The method of claim 1, further comprising deleting a message representative of the task in the queueing system in response to one or more of the task being completed and the task failing.

8. A non-transitory computer-readable storage medium coupled to one or more processors and having instructions stored thereon which, when executed by the one or more processors, cause the one or more processors to perform operations for asynchronous task execution in cloud-based systems, the operations comprising:
generating, by a task generation service, task metadata representative of a task that is to be executed in the a cloud-based system;
recording the task metadata in a table of a database system;
publishing the task metadata to a queueing system;
receiving, by a task consuming service of a plurality of task consuming services, the task metadata from the queueing system;
executing, by the task consuming service, the task; and
during execution, updating a state of the task within the table of the database system.

9. The non-transitory computer-readable storage medium of claim 8, wherein executing the task is performed in response to validating the task by determining that the state of the task indicates that the task is to be executed.

10. The non-transitory computer-readable storage medium of claim 9, wherein executing the task is performed further in response to validating the task by determining that any precedent task identified in the task metadata was successfully executed.

11. The non-transitory computer-readable storage medium of claim 8, wherein the task metadata comprises a retry configuration that defines one or more retriable errors, each representing a respective error, in response to which a retry of execution of the task is allowed.

12. The non-transitory computer-readable storage medium of claim 11, wherein the retry configuration further defines one or more retry intervals for the one or more retriable errors.

13. The non-transitory computer-readable storage medium of claim 8, wherein the task consuming service receives the task metadata in response to the task consuming service being subscribed to the task with the queueing system.

14. The non-transitory computer-readable storage medium of claim 8, wherein operations further comprise deleting a message representative of the task in the queueing system in response to one or more of the task being completed and the task failing.

15. A system, comprising:
a computing device; and
a computer-readable storage device coupled to the computing device and having instructions stored thereon which, when executed by the computing device, cause the computing device to perform operations for asynchronous task execution in cloud-based systems, the operations comprising:
generating, by a task generation service, task metadata representative of a task that is to be executed in the a cloud-based system;
recording the task metadata in a table of a database system;
publishing the task metadata to a queueing system;
receiving, by a task consuming service of a plurality of task consuming services, the task metadata from the queueing system;
executing, by the task consuming service, the task; and
during execution, updating a state of the task within the table of the database system.

16. The system of claim 15, wherein executing the task is performed in response to validating the task by determining that the state of the task indicates that the task is to be executed.

17. The system of claim 16, wherein executing the task is performed further in response to validating the task by determining that any precedent task identified in the task metadata was successfully executed.

18. The system of claim 15, wherein the task metadata comprises a retry configuration that defines one or more retriable errors, each representing a respective error, in response to which a retry of execution of the task is allowed.

19. The system of claim 18, wherein the retry configuration further defines one or more retry intervals for the one or more retriable errors.

20. The system of claim 15, wherein the task consuming service receives the task metadata in response to the task consuming service being subscribed to the task with the queueing system.
